(19) United States
(12) Patent Application Publication
(10) Pub. No.: US 2014/0252172 A1
(43) Pub. Date: Sep. 11, 2014

(54) SINGLE SURFACE ELECTRO-MECHANICAL ACTUATOR ASSEMBLY

(71) Applicant: PARVIZ ACQUISITIONS LLC, Los Angeles, CA (US)

(72) Inventor: Brandon M. Bridgeford, Eastvale, CA (US)

(21) Appl. No.: 14/198,090

(22) Filed: Mar. 5, 2014

Related U.S. Application Data
(60) Provisional application No. 61/773,057, filed on Mar. 5, 2013.

(51) Int. Cl. B64D 15/16

(52) U.S. Cl. CPC B64D 15/163
USPC 244/134 A

(57) ABSTRACT

The current invention is directed to a self-contained electro-expulsive actuator assembly capable of being attached and operating external to an object, and methods of providing an electro-expulsive force external to an object. During operation the deformation or flexing of the electro-expulsive actuator causes deformation of an integral outer skin which is overlaid over the outer surface of the underlying structure, thereby causing unwanted build-up of residues on the outer skin of the actuator assembly to be expelled.

### CROSS-REFERENCE TO RELATED APPLICATIONS

The present application claims priority to U.S. Provisional Application No. 61/773,057, filed Mar. 5, 2013, the disclosure of which is incorporated herein by reference.

### FIELD OF THE INVENTION

The present invention generally relates to electro-mechanical actuator assemblies; and more particularly to electro-mechanical actuator assemblies capable of being affixed to the outside surface of a structure.

### BACKGROUND

An “electro-expulsive actuator”, also sometimes referred to as an “electro-mechanical expulsive actuator”, as used for example, in de-icing or removing unwanted residue build-up from an object, uses electrically produced mechanical motion to produce a shockwave in the surface of the object to be cleaned. These types of devices are particularly useful in applications where the surface of the object to be cleared is either inaccessible or hazardous, such as, for example, de-icing the wing of an aircraft during flight.

A typical electro-expulsive de-icing system includes electro-mechanical transducers called “actuators” that are installed beneath the outer surface of an object (e.g., in an aircraft the leading edges of wings, horizontal and vertical stabilizers, and engine inlets). An electronic control system then passes large current pulses through such actuators (e.g., thousands of amperes expelled in pulses having millisecond durations pulses at predetermined intervals) in order to thereby produce mechanical motion that produces shock waves in the surface of the object to be cleared. The shock waves result in dislodgement of the undesirable residue (such as, for example, ice) that has accumulated on the object surface. In short, the actuator imparts energy to the inner surface of the object that action produces the shock waves in the object surface, and the shock waves knock the accumulated residue off the outer surface of the object.

Some such existing electro-expulsive actuators include strips or ribbons of copper or other electrically conductive material that are mounted in closely-spaced-apart parallel orientation. Electric current flowing as mentioned above causes the strips to accelerate apart from each other in a manner creating residue-removing shock waves. The electrically conductive strips for some actuators take the form of a copper ribbon wrapped in an elongated multi-turn loop (i.e., a multi-turn coil). In some of these devices, molded blocks of polyurethane encapsulate the two opposite folded ends of the loop while a dielectric coating on the copper ribbon prevents shorting between adjacent turns. Interconnection of the copper ribbon loop to the onboard electronic control system results in electric current pulses flowing in a first direction in a first half of the loop (from a first folded end of the loop to an opposite second folded end), and in an opposite second direction in a second half of the loop (from the second folded end of the loop to the first folded end). As an electric current pulse flows that way, it results in a large force that tends to mutually repel the first and second halves of the loop. That repulsion results in relative movement of the first and second halves away from each other in a pulse of mechanical motion that is coupled to the aircraft skin. That mechanical pulse results in the residue removing shock waves. (See, e.g., U.S. Pat. Pub. No. 2010/0288882, the disclosure of which is incorporated herein by reference.)

Although these electro-expulsive systems do provide many advantages over conventional de-icing systems based on, for example, heat generation, these systems typically must be affixed inside the body of the surface to be de-iced, such as, within the leading edge of a wing, for example. Obviously, this limits the ability to retrofit existing aircraft with these de-icing systems. Accordingly, a need exists for self-contained electro-expulsive actuators that can be attached and operate external to a structure.

### SUMMARY OF THE INVENTION

The current invention is directed to a self-contained electro-expulsive actuator assembly capable of being attached and operating external to an object, and methods of providing an electro-expulsive force external to an object.

In some embodiments, the invention is directed to an externally mountable electro-expulsive assembly including:
an actuator including a plurality of separate adjacently positioned electrically conductive elements configured in a conductive loop such that a current run through said conductive loop imparts an orthogonal motion in said actuator;
an outer actuator skin mechanically interconnected with said actuator such that the orthogonal motion of said actuator imparts an expulsive shockwave in said outer actuator skin; and
wherein the outer actuator skin is configured to at least partially shield the outer surface of an underlying structure.

In some embodiments, the actuator is directly mounted to the outer surface of the underlying structure.

In other embodiments, the outer actuator skin has at least one portion directly interconnected with the outer surface of the underlying structure.

In still other embodiments, the outer actuator skin is configured to duplicate the outer contour of the outer surface of the underlying structure.

In yet other embodiments, the outer actuator skin forms a seal with the outer surface of the underlying structure such that the actuator is completely shielded from the external environment.

In still yet other embodiments, the outer actuator skin fully encapsulates the actuator.

In still yet other embodiments, the assembly further comprises an interposing structure between the actuator and at least one of the outer actuator skin and the outer surface of the underlying structure.

In still yet other embodiments, the outer actuator skin fully covers the outer surface of the underlying structure.

In still yet other embodiments, the underlying structure is the leading edge of an aircraft wing.

In still yet other embodiments, the conductive elements are interconnected at their ends via one or more flexible conductive interconnects. In some such embodiments the flexible conductive interconnects are selected from the group consisting of wires, flexible capable, and U-shaped conductive ribbons.

In other embodiments the invention is directed to an externally mountable electro-expulsive assembly including:
an actuator including a plurality of separate adjacently positioned electrically conductive elements configured in a conductive loop such that a current run through said conductive loop imparts an orthogonal motion in said actuator;
an outer actuator skin mechanically interconnected with said actuator such that the orthogonal motion of said actuator imparts an expulsive shockwave in said outer actuator skin; and
wherein the outer actuator skin is configured to duplicate the outer contour of the outer surface of at least a portion of an aircraft wing, such that the outer actuator skin forms a seal with the outer surface of the aircraft wing such that the actuator is completely shielded from the external environment.

In still other embodiments, the invention is directed to methods of preventing the build-up of residue from an underlying structure including:
providing an underlying structure having an outer surface;
disposing atop the outer surface of the underlying structure an outer actuator skin configured to at least partially shield the outer surface of the underlying structure; and
wherein the outer actuator skin further comprises an actuator mechanically interconnected therewith, the actuator comprising a plurality of separate adjacently positioned electrically conductive elements configured in a conductive loop such that a current run through said conductive loop imparts an orthogonal motion in said actuator, such that the orthogonal motion of said actuator imparts an expulsive shockwave in said outer actuator skin.

In some embodiments, the actuator is directly mounted to the outer surface of the underlying structure.

In other embodiments, the outer actuator skin has at least one portion directly interconnected with the outer surface of the underlying structure.

In still other embodiments, the outer actuator skin is configured to duplicate the outer contour of the outer surface of the underlying structure.

In yet other embodiments, the outer actuator skin forms a seal with the outer surface of the underlying structure such that the actuator is completely shielded from the external environment.

In still yet other embodiments, the outer actuator skin fully encapsulates the actuator.

In still yet other embodiments, the method further includes disposing an interposing structure between the actuator and at least one of the outer actuator skin and the outer surface of the underlying structure.

In still yet other embodiments, the outer actuator skin fully covers the outer surface of the underlying structure.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1a illustrates a schematic of an externally applicable electro-expulsive actuator assembly in accordance with an embodiment of the invention.

FIG. 1b illustrates a cross-sectional detail of an electro-expulsive actuator in accordance with an embodiment of the invention.

FIG. 2a illustrates a cross-section side-view of an externally applicable electro-expulsive actuator assembly in accordance with an embodiment of the invention.

FIG. 2b illustrates a cross-sectional detail of an electro-expulsive actuator in accordance with an embodiment of the invention.

FIG. 3 illustrates a schematic of an electro-expulsive actuator in accordance with an embodiment of the invention.

FIG. 4 illustrates an operational schematic of an electro-expulsive actuator in accordance with an embodiment of the invention.

### DETAILED DESCRIPTION OF THE INVENTION

Turning now to the drawings, systems and methods for implementing externally attached electro-expulsive actuators for residue removal are illustrated. In many embodiments, the self-contained electro-expulsive actuators are capable of operating while engaged with the outer surface of on object, such as the leading edge of a wing, windmill propeller, reaction vessel, etc. In many embodiments, rather than being mounted internal to a structure and striking an inside surface of the structure or creating a shockwave from the inside of the structure, the actuator assembly of the current invention is formed of an electro-expulsive actuator and an integral outer skin, this assembly is then disposed external the underlying structure and partially covers the outer surface of the structure thereby at least partially shielding the underlying structure from external environments so that residue build-up occurs partially or wholly on the integral outer skin of the actuator assembly and not the underlying structure. In many embodiments, during operation the deformation or flexing of the electro-expulsive actuator causes deformation of the integral outer skin of the actuator, which is overlaid over the outer surface of the underlying structure, thereby causing unwanted build-up of residue on the outer skin of the actuator assembly to be expelled.

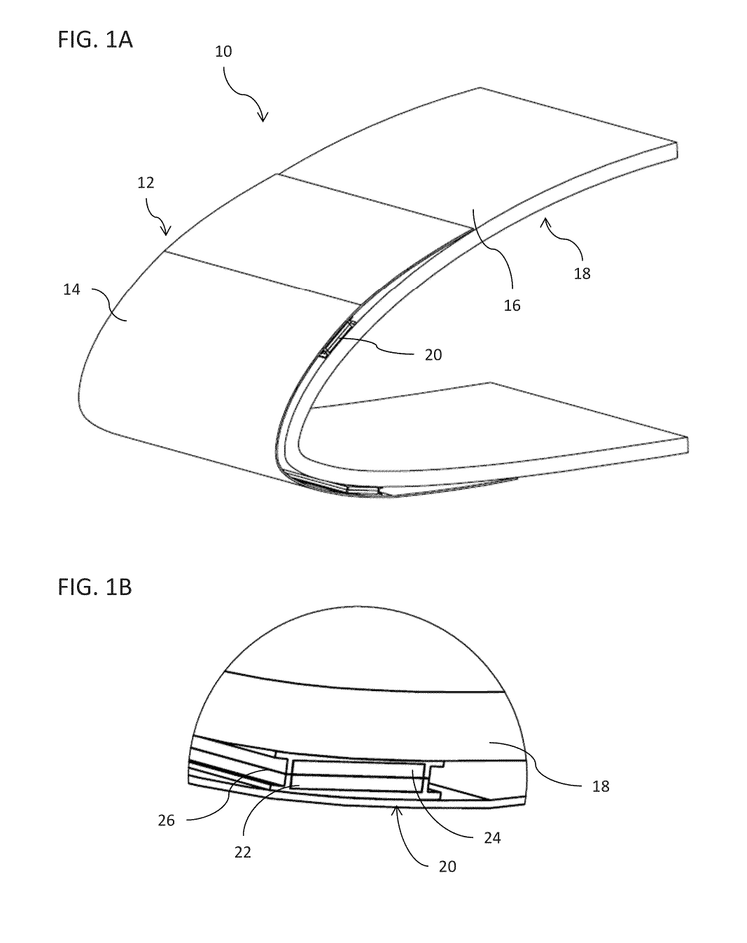

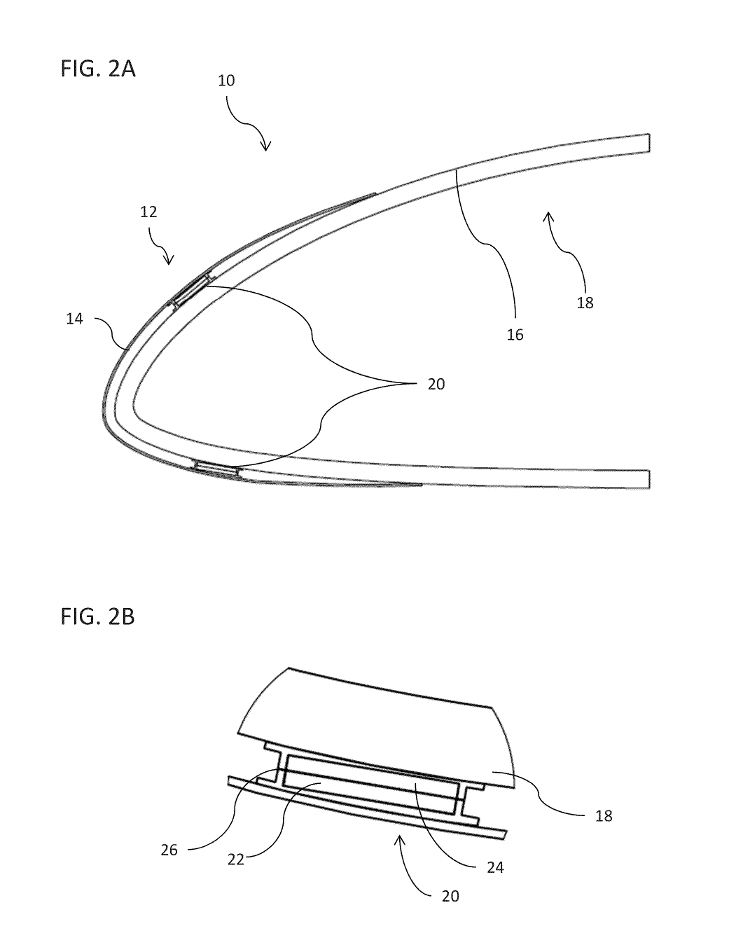

FIGS. 1A and 2A illustrate embodiments of externally mountable electro-expulsive actuator assembly (10). As shown, in an embodiment the actuator (12) is provided as part of a system that would include an electronic control system (i.e., an electro-expulsive control system connected to the actuator through provided electrical leads, not shown) and the actuator (12) itself that is mounted on or encased in association with an integral outer shielding surface or skin (14). It should be understood that the outer shielding surface or skin (14) may be of any form, shape and length capable of covering the actuator (12), and being contoured to at least partially shield the outer surface (16) of a supporting structure (18). In some embodiments the shielding outer surface/skin would be formed to recreate the contour or surface profile of the outer surface (16) of the supporting structure, thereby serving as a new outer surface of the supporting structure. The supporting structure may include any structure (e.g., the leading edge of a wing or other aircraft structure, a windmill propeller or a reaction vessel) that would otherwise be exposed to environments or materials that could form unwanted residue thereon (e.g., an ice or other chemical residue).

Although embodiments of the externally mountable electro-expulsive systems in relation to the leading edge of a wing are shown in FIGS. 1A and 1B, it should be understood that the electro-expulsive systems may be formed in relation to the underlying structure in any suitable configuration. For example, in many embodiments the entire electro-expulsive system may be anchored to the underlying structure through the actuator assemblies, as via a suitable interconnection, such as adhesive, mechanical, welds, etc. In other embodiments, additional fasteners may interconnect the outer surface of the electro-expulsive system directly with the underlying structure. It will be understood that such interconnection may utilize any suitable means, such as mechanical fasteners, welds, adhesives etc. In addition, in other embodiments a seal may be interposed between the outer surface of the electro-expulsive system and the underlying structure to provide a seal preventing the introduction of any external material into the space formed between the outer surface of the electro-expulsive system and the underlying structure. Such a seal may take any suitable form, and may include a resilient membrane or other flexible gasket or seal.

Although the embodiments shown in FIGS. 1A and 2A provide illustrations where the assembly (10) is disposed in relation to the underlying structure such that the actuator (12) is directly attached to the outer surface (16) of the supporting structure (18), and the shielding surface/skin (14) of the actuator assembly is disposed external to the actuator, it should be understood that other mounting arrangements may be employed for creating electro-expulsive shockwaves in the exposed surface or surfaces. For example, the while the actuator may be bonded directly to one or both of the underlying structure and the shielding surface/skin, other force transfer or support structures could be interposed between the actuator and one or both of the underlying structure and the shielding surface/skin.

Schematic embodiments of the actuator (20), mounted in relation to underlying structure and the shielding surface/skin are shown in FIGS. 1B and 2B. As shown, the actuator is comprised of active conductor elements (22 & 24) and an actuator support structure (26). In operation, the active conductors would electro-elastically operate to deform the actuator support structure to create shock-waves in the shielding surface/skin (14) to dislodge any residue that may have formed on the shielding surface/skin. In particular, the active conductors (22 & 24) respond to electronic pulses from the control system (as described below) by flexing the surrounding actuator support structure member (26), thereby producing movement along the outer shielding surface/skin (14) of the assembly to dislodge residue that has formed on that outer shielding surface/skin of the assembly. It should be understood that the actuator may be bonded to the underlying structure and shielding structure in any suitable manner, such as, for example, through adhesives, mechanical connectors, welds, etc.

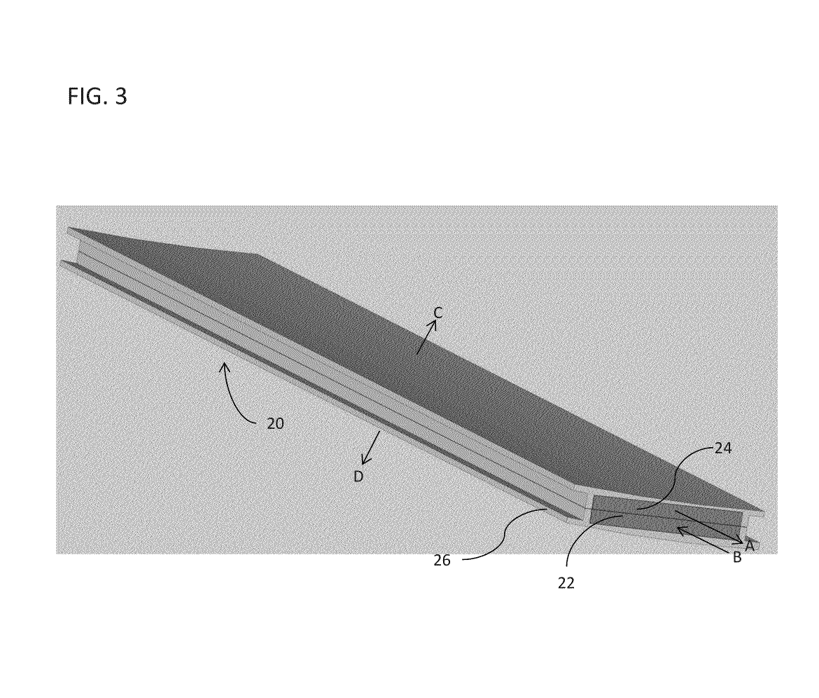

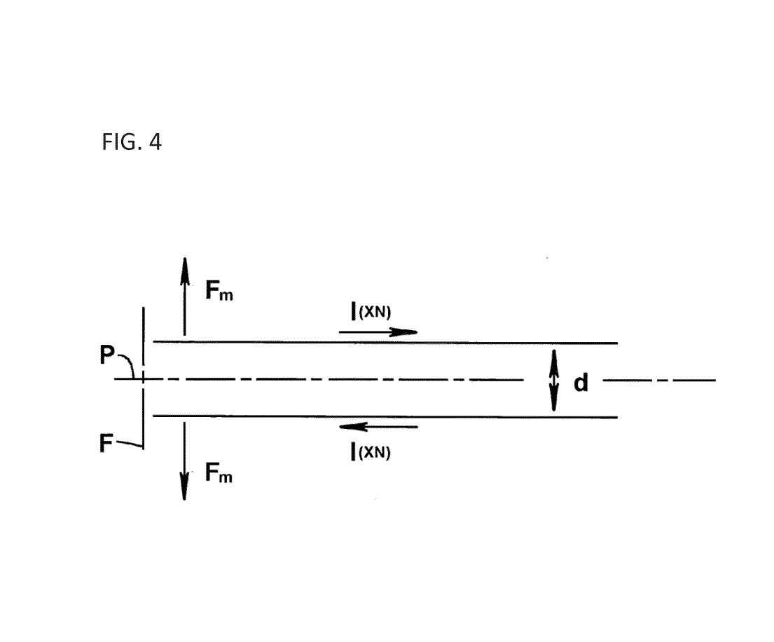

As shown in FIG. 3, the actuator includes at least two electrically conductive ribbons or strips (22 and 24) electrically connected at a connection to an electronic control system (not shown). The ribbons or strips are electrically interconnected to make a single electrical conducting path or loop such that a first ribbon or strip (22) conducts electric pulses in a first direction (indicated by an arrow B), and a second ribbon or strip (24) conducts the electric pulses in an opposite second direction (indicated by an arrow A). As electric current pulses flow that way, the first and second strips (22 & 24) move apart from each other as indicated by arrows C and D. That movement creates a pulse of mechanical energy that creates residue-removing movement/force in the skin of the integral shielding surface or other object to be de-iced for ice-removal purposes with a force Fm, as shown schematically in FIG. 4. Although FIGS. 1B and 2B show exemplary embodiments of actuators having two actuator elements (22 and 24), it should be understood that the actuator may contain many such elements arrayed in any configuration of multi-turn electrically conductive loops (i.e., a multi-turn coils) that can carry movement-producing electric pulses to produce mechanical energy in a direction orthogonal to that current.

In many embodiments, the ends of elements of the actuator are interconnected in a configuration that allows for a level of freedom of movement. In some embodiments, the multiple elements may be interconnected by flexible connectors taking the form of jumper wires fabricated from lengths of stranded wire or cable. The connectors serve as means electrically interconnecting various ones of the terminal ends of the elements in order to thereby form the electrically conductive loop. The connectors in such an embodiment may be soldered or otherwise suitably connected to the ends of the elements. In alternative embodiments, the connectors of the actuator may be sections of conductive ribbon in U-shaped configurations (e.g., similar in width and thickness to the ribbon composition of the electrically conductive elements of the first and second subassemblies). Regardless of the interconnection chosen, the connectors form U-shaped loops to minimize the restrictive effect of the mid portion on relative movement of the first and second subassemblies. In still another embodiment, (not shown) the axes of elongation of the connectors may be oriented so that their axes of elongation are perpendicular to the direction of elongation of the electrically conductive loop. That connector orientation is important in some installations for reducing the overall length of the actuator. (Some suitable designs of actuator assemblies are provided in U.S. Pat. Pub. No. 2010/0288882, the disclosure of which is incorporated herein by reference.)

It should be understood that though a few examples of actuator assemblies and actuators have been briefly described above, the actuator assembly of the instant invention may take any form necessary to ensure the desired underlying structure is at least partially shielded against residue build-up. In particular, the number and placement of actuators, the design of the shielding surface/skin, and the number of assemblies used to protect the underlying structure may any suitable form depending on the application and underlying surface structure to be shielded against residue build-up. For example, the actuator could take any shape suitable for creating an electro-expulsive force in the integral outer skin of the assembly and for attaching to the outer surface of the underlying structure. In turn, the integral outer shielding surface/skin of the assembly could take any form, shape or number such that it at least partially shields the outer surface of the underlying structure. It should be understood that the shielding skin/surface of the assembly may be designed to cover the entire underlying structure or only portions thereof. Likewise, the shielding surface/skin of the assembly could be formed to match the contour or profile of the underlying structure thereby serving as a new outer surface. For example, on an aircraft where the actuator assembly is to be positioned to prevent icing on a leading edge of a wing, the actuator would be attached to the outside surface of the wing and the shielding surface/skin in such embodiments would then serve as the new leading edge of the wing. In short, any assembly design could be used so long as the actuator is mounted between the outer surface of the underlying structure and an integral shielding surface/skin such that residue builds up on the assembly and not the underlying structure, and such that deformation of the actuator causes a residue removal force to be propagated through the shielding surface/skin thereby removing any unwanted residue on the assembly.

Thus, the invention provides an electro-expulsive de-icing actuator assembly that allows for such a system to be appended to an existing structure. The system and actuator assemblies may be used for a variety of residue-removal applications including in-flight aircraft de-icing. The electro-expulsive de-icing assemblies can be fabricated in any configuration for applications as varied as ship board communication antennas, bridge cabling, windmill propellers, and so forth, and in a flat panel configuration for applications such as river way locks or ship board superstructure and so forth.

### Doctrine of Equivalents

Although exemplary embodiments have been shown and described, one of ordinary skill in the art may make many changes, modifications, and substitutions without necessarily departing from the spirit and scope of the invention. Those skilled in the art will appreciate that the foregoing examples and descriptions of various preferred embodiments of the present invention are merely illustrative of the invention as a whole, and that variations in the steps and various components of the present invention may be made within the spirit and scope of the invention. As for the specific terminology used to describe the exemplary embodiments, it is not intended to limit the invention; each specific term is intended to include all technical equivalents that operate in a similar manner to accomplish a similar purpose or function. Accordingly, the present invention is not limited to the specific embodiments described herein but, rather, is defined by the scope of the appended claims.

What is claimed:

1. An externally mountable electro-expulsive assembly comprising:
an actuator comprising a plurality of separate adjacently positioned electrically conductive elements configured in a conductive loop such that a current run through said conductive loop imparts an orthogonal motion in said actuator;
an outer actuator skin mechanically interconnected with said actuator such that the orthogonal motion of said actuator imparts an expulsive shockwave in said outer actuator skin; and
wherein the outer actuator skin is configured to at least partially shield the outer surface of an underlying structure.

2. The assembly of claim 1, wherein the actuator is directly mounted to the outer surface of the underlying structure.

3. The assembly of claim 1, wherein the outer actuator skin has at least one portion directly interconnected with the outer surface of the underlying structure.

4. The assembly of claim 1, wherein the outer actuator skin is configured to duplicate the outer contour of the outer surface of the underlying structure.

5. The assembly of claim 1, wherein the outer actuator skin forms a seal with the outer surface of the underlying structure such that the actuator is completely shielded from the external environment.

6. The assembly of claim 1, wherein the outer actuator skin fully encapsulates the actuator.

7. The assembly of claim 1, further comprising an interposing structure between the actuator and at least one of the outer actuator skin and the outer surface of the underlying structure.

8. The assembly of claim 1, wherein the outer actuator skin fully covers the outer surface of the underlying structure.

9. The assembly of claim 1, wherein the underlying structure is the leading edge of an aircraft wing.

10. The assembly of claim 1, wherein the conductive elements are interconnected at their ends via one or more flexible conductive interconnections.

11. The assembly of claim 8, wherein the flexible conductive interconnections are selected from the group consisting of wires, flexible capable, and U-shaped conductive ribbons.

12. An externally mountable electro-expulsive assembly comprising:
an actuator comprising a plurality of separate adjacently positioned electrically conductive elements configured in a conductive loop such that a current run through said conductive loop imparts an orthogonal motion in said actuator;
an outer actuator skin mechanically interconnected with said actuator such that the orthogonal motion of said actuator imparts an expulsive shockwave in said outer actuator skin; and
wherein the outer actuator skin is configured to duplicate the outer contour of the outer surface of at least a portion of an aircraft wing, such that the outer actuator skin forms a seal with the outer surface of the aircraft wing such that the actuator is completely shielded from the external environment.

13. A method of preventing the build-up of residue from an underlying structure comprising:
providing an underlying structure having an outer surface;
disposing atop the outer surface of the underlying structure an outer actuator skin configured to at least partially shield the outer surface of the underlying structure; and
wherein the outer actuator skin further comprises an actuator mechanically interconnected therewith, the actuator comprising a plurality of separate adjacently positioned electrically conductive elements configured in a conductive loop such that a current run through said conductive loop imparts an orthogonal motion in said actuator, such that the orthogonal motion of said actuator imparts an expulsive shockwave in said outer actuator skin.

14. The method of claim 13, wherein the actuator is directly mounted to the outer surface of the underlying structure.

15. The method of claim 13, wherein the outer actuator skin has at least one portion directly interconnected with the outer surface of the underlying structure.

16. The method of claim 13, wherein the outer actuator skin is configured to duplicate the outer contour of the outer surface of the underlying structure.

17. The method of claim 13, wherein the outer actuator skin forms a seal with the outer surface of the underlying structure such that the actuator is completely shielded from the external environment.

18. The method of claim 13, wherein the outer actuator skin fully encapsulates the actuator.

19. The method of claim 13, further comprising disposing an interposing structure between the actuator and at least one of the outer actuator skin and the outer surface of the underlying structure.

20. The method of claim 13, wherein the outer actuator skin fully covers the outer surface of the underlying structure.
